(19) United States
(12) Patent Application Publication
(10) Pub. No.: US 2022/0247660 A1
(43) Pub. Date: Aug. 4, 2022

(54) COLLECTION AND AGGREGATION OF STATISTICS FOR OBSERVABILITY IN A CONTAINER BASED NETWORK

(71) Applicant: Tigera, Inc., San Francisco, CA (US)

(72) Inventors: Manish Haridas Sampat, San Jose, CA (US); Karthik Krishnan Ramasubramanian, Newark, CA (US); Shaun Crampton, London (GB); Sridhar Mahadevan, Vancouver (CA); Tomas Hruby, Vancouver (CA)

(21) Appl. No.: 17/351,610

(22) Filed: Jun. 18, 2021

Related U.S. Application Data
(60) Provisional application No. 63/143,512, filed on Jan. 29, 2021.

(51) Int. Cl. H04L 12/26; H04L 29/12; H04L 29/06

(52) U.S. Cl. CPC H04L 43/12; H04L 43/028; H04L 69/22; H04L 43/04; H04L 61/256; H04L 43/062

(57) ABSTRACT

Information associated with a data packet sent to or from a network interface associated with a cluster node is obtained. The information associated with the data packet is correlated to a particular computing unit associated with the cluster node. The information associated with the data packet and information associated with the particular computing unit is aggregated across processes running on the particular computing unit. The aggregated information associated with the particular computing unit is provided to a flow log analyzer.

### CROSS REFERENCE TO OTHER APPLICATIONS

This application claims priority to U.S. Provisional Patent Application No. 63/143,512 entitled COLLECTION AND AGGREGATION OF STATISTICS FOR OBSERVABILITY IN A CONTAINER BASED NETWORK filed Jan. 29, 2021 which is incorporated herein by reference for all purposes.

### BACKGROUND OF THE INVENTION

Collecting data for observability in container-based networks is challenging due to the ephemeral nature of containers. In the course of normal operation, a container is created and destroyed several times depending on various factors like resource availability, traffic characteristics, etc. Several containers may be running on any host and there may be several hosts in a network, which causes there to be a large amount of network data. This makes it even harder for some systems that collect all data separately for various metrics to correlate the data with specific containers after the fact.

### BRIEF DESCRIPTION OF THE DRAWINGS

Various embodiments of the invention are disclosed in the following detailed description and the accompanying drawings.

FIG. 1 is a block diagram illustrating an embodiment of a system for obtaining, correlating, and aggregating flow events.

FIG. 2 is a flow diagram illustrating an embodiment of a process for obtaining, correlating, and aggregating flow events.

FIG. 3 is a flow diagram illustrating an embodiment of a process for obtaining information associated with a data packet.

FIG. 4 is a flow diagram illustrating an embodiment of a process of correlating a flow event with a particular computing unit.

FIG. 5 is a flow diagram illustrating an embodiment of a process for aggregating information associated with a data packet and information associated with a particular computing unit across processes running in a particular computing unit.

FIG. 6 is a flow diagram illustrating an embodiment of a process for aggregating information associated with a data packet with information associated with a particular computing unit across processes running on a particular computing unit.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques to collect network traffic, correlate the network traffic to a particular computing unit, and aggregate the network traffic for the particular computing unit are disclosed. Containerized applications are implemented by deploying computing units (e.g., pods) to computing unit hosts (e.g., a virtual machine, a physical server). The computing unit hosts are hosted on nodes of a physical cluster. A computing unit is the smallest deployable unit of computing that can be created to run one or more containers with shared storage and network resources. A computing unit is configured to run a single instance of a container (e.g., a microservice) or a plurality of containers. The one or more containers of the computing unit are configured to share the same resources and local network of the computing unit host on which the computing unit is deployed.

When deployed to a computing unit host, a computing unit has an associated internet protocol (IP) address. The lifetime of a computing unit is ephemeral in nature. As a result, the IP address assigned to the computing unit may be reassigned to a different computing unit that is deployed to the computing unit host. In some embodiments, a computing unit is migrated from one computing unit host to a different computing unit host. The computing unit may be assigned a different IP address on the different computing unit host.

A kernel of a computing unit host is configured to generate a flow event that includes the standard network 5-tuple flow data (source IP address, source port, destination IP address, destination port, protocol (e.g., TCP (Transmission Control Protocol), UDP (User Datagram Protocol))) when a data packet is received at a network interface associated with a computing unit. As computing units continue to be instantiated and torn down, the flow events associated with these computing units are aggregated in a flow log. Analyzing the flow data having the standard network 5-tuple flow data without additional information is a difficult task because using the IP address by itself is insufficient to determine which computing units sent and/or received a data packet due to the ephemeral nature of their IP addresses. Furthermore, analyzing the flow data solely using the standard network 5-tuple flow data makes it difficult to determine whether there are any problems (e.g., network connection, scale, etc.) associated with a computing unit.

The techniques disclosed herein enable a flow event to be associated with a particular computing unit, even if the IP associated with the particular computing unit changes or has changed. A packet analyzer, such as an enhanced Berkeley Packet Filter, is attached to a network interface associated with a computing unit. The packet analyzer is preconfigured (e.g., by a daemon running on the computing unit host) with network namespace information, which enables the packet analyzer to lookup a socket that is associated with the network namespace.

In response to receiving a data packet (e.g., a data packet sent from/to a computing unit), the packet analyzer is configured to obtain information associated with the data packet by using information included in the standard network 5-tuple flow data to perform a lookup of socket information. The packet analyzer is configured to call a kernel helper function to lookup the socket passing in the network namespace id. The kernel is configured to provide socket information (e.g., Linux socket data structure) to the packet analyzer.

In response to receiving the socket information, the packet analyzer is configured to extract network statistics, such as round-trip time, a size of a send window, etc., from the socket information. The round-trip time and the size of the send window may indicate whether there are any network connection problems associated with the computing unit. For example, a low round-trip time (e.g., a round-trip time less than a threshold round-trip time) may indicate that the network connection associated with the computing unit is not experiencing any problems while a high round-trip time (e.g., a round-trip time greater than the threshold round-trip time) may indicate that the network connection associated with the computing unit is experiencing problems. A large send window size (e.g., a window size greater than a window size threshold) may indicate that a TCP socket is ready to receive data packets while a small send window size (e.g., a window size less than the window size threshold) may indicate that the TCP socket has scaled back and is rejecting data packets. The packet analyzer is configured to provide the network statistics to a flow log agent (e.g., user space program), which can associate the network statistics with a flow event. The network statistics may be used to determine whether there are any network connection problems associated with the computing unit.

In some embodiments, the packet analyzer is configured to use one or more kernel hooks to obtain additional information associated with the data packet. For example, the packet analyzer may use a netlink socket along with NFLogs to obtain information associated with a network policy acting on network traffic. The packet analyzer may use a conntrack hook, which provides connection tracking to obtain network address translated (NAT) information. For example, a data packet received at a computing unit may have the IP address of the computing unit as the destination IP address. The computing unit may include one or more containers having corresponding IP addresses that are different than the IP address of the computing unit. The data packet may be forwarded to one of the containers. The destination IP address of the computing unit may be translated to the IP address of the container that received the data packet.

The flow log agent is configured to program the kernel to provide flow events associated with each of the computing units on the computing unit host to the flow log agent. In response to receiving a flow event, the flow log agent is configured to correlate the flow event with metadata associated with a computing unit (e.g., cluster identity, namespace identity, computing unit identity, one or more computing unit labels) to generate a scalable network flow event and log the scalable network flow event in a flow log. A computing unit is running one or more processes. The flow log agent is configured to include additional fields, such as a process name field and a process id field, to the flow log metadata for a scalable network flow event. This enables a single flow event to be attributed to one of the processes running in the computing unit. For example, the scalable network flow event in the flow log may have the form {source IP address, destination IP address, source port, destination port, protocol, computing unit metadata, process name, process id}. When the flow log is reviewed at a later time, the flow log event may be easily understood as to which computing unit communicated with which other computing units in the cluster and/or endpoints external to the cluster and with which process the flow log event is associated because the flow log events are associated with a particular computing unit and a particular process. The flow log event can be used to determine if an associated process is a source process or a destination process.

The flow log agent is configured to program the kernel of the computing unit host on which the flow log agent is deployed to provide additional information associated with the data packet, such as network statistics, network policy information, NAT information, etc. In response to receiving the additional information associated with the data packet, the flow log agent is configured to associate the additional information with a flow event for a particular computing unit. In some embodiments, the additional information is appended to a scalable network flow event.

A containerized application is comprised of a plurality of different processes. The containerized application includes one or more computing units that include one or more corresponding containers. In some embodiments, a computing unit includes a single container that provides a process. In some embodiments, a computing unit includes a plurality of containers that provide a plurality of processes. The number of computing units that provide the same process may be increased or decreased over time. Each of the computing units providing the same process may be referred to as a replica set. A flow log agent may be configured to aggregate scalable network flow events on a per replica set basis. This may not provide useful information about the process for analysis purposes because it provides an incomplete view of the process due to the ephemeral nature of a computing unit and makes it difficult to determine if there are any problems with the process at any point in time.

Instead, for an aggregation interval (e.g., 10 minutes), the flow log agent is configured to aggregate scalable network flow events for the one or more replica sets providing process(es) that have the same process name prefix. This enables an overall view of the process within the aggregation interval to be inferred and enables potential problems associated with the process to be identified. For example, the number of times a process restarted, changed, or crashed may be determined. A process that has been restarted more than a threshold number of times within the aggregation interval may indicate malicious activity associated with the process.

The flow log agent identifies the scalable network flow events associated with the same process based on the process name information stored in a scalable network flow event. In some embodiments, there is a single process associated with a process name prefix, but the process id associated with a process is changing because the process has been torn down, restarted, crashed, etc. The flow log agent is configured to indicate the number of times that the process id associated with the process has changed. Instead of recording each process id for a particular process, the flow log agent may set a flag or store an identifier, such as “*”, to indicate that a plurality of process ids are associated with the process. This may reduce the amount of data stored by the flow log and provided to a flow log analyzer. When the flow log is sent to a flow log analyzer, the flag or identifier may indicate to the flow log analyzer that there may have been a problem with the process within the aggregation interval.

In some embodiments, there are a plurality of processes associated with a process name prefix. The flow log agent is configured to aggregate the number of processes that share the process name prefix and the number of process ids associated with the plurality of processes. Instead of aggregating the individual process names and the individual process ids, the flow log agent may be configured to represent the individual process names and/or the individual process ids using a flag or an identifier, such as “*”, to indicate that a plurality of processes share the process name prefix. This reduces the amount of information that is stored by the flow log, enables the flow log to handle an increase in scale of replica sets during the aggregation interval, and reduces the amount of information that is transmitted to the flow log analyzer.

In some embodiments, the flow log agent is configured to separately aggregate information for a threshold number of unique process names, beyond which the other processes having unique names are jointly aggregated. For example, the threshold number of unique process names may be two. The flow log agent may separately aggregate information for the first and second processes, but information for other processes having the prefix is jointly aggregated. This reduces the amount of information that is stored by the flow log, enables the flow log to handle an increase in scale of replica sets during the aggregation interval, and reduces the amount of information that is transmitted to the flow log analyzer.

After the aggregation interval has passed, the flow log agent is configured to provide the aggregated information to a flow log analyzer. By periodically providing the aggregated information, the flow log analyzer can use the aggregated information to determine a specific time period where a particular process of a containerized application may have been experiencing problems or if a particular process needs to be scaled up.

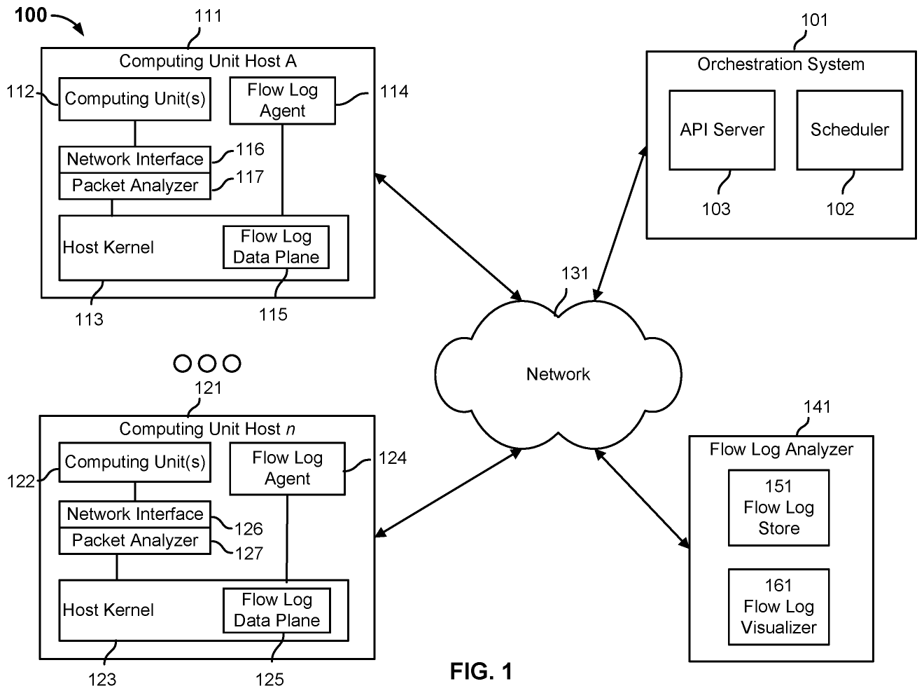

FIG. 1 is a block diagram illustrating an embodiment of a system for obtaining, correlating, and aggregating flow events. In the example shown, system 100 includes orchestration system 101, host 111, host 121, network 131, and flow log analyzer 141.

System 100 includes one or more servers hosting a plurality of computing unit hosts. Although system 100 depicts two computing unit hosts, system 100 may include n computing unit hosts where n is an integer greater than one. In some embodiments, a computing unit hosts 111, 121 are virtual machines running on a computing device, such as a computer, server, etc. In other embodiments, computing unit hosts 111, 121 are running on a computing device, such as on-prem servers, laptops, desktops, mobile electronic devices (e.g., smartphone, smartwatch), etc. In other embodiments, computing unit hosts 111, 121 are a combination of virtual machines running on one or more computing devices and one or more computing devices.

Computing unit hosts 111, 121 are configured to run a corresponding operating system (e.g., Windows, MacOS, Linux, etc.) and include a corresponding kernel 113, 123 (e.g., Windows kernel, MacOS kernel, Linux kernel, etc.). Computing unit hosts 111, 121 include a corresponding set of one or more computing units 112, 122. A computing unit (e.g., a pod) is the smallest deployable unit of computing that can be created to run one or more containers with shared storage and network resources. In some embodiments, a computing unit is configured to run a single instance of a container (e.g. microservice). In some embodiments, a computing unit is configured to run a plurality of containers.

Orchestration system 101 is configured to automate, deploy, scale, and manage containerized applications. Orchestration system 101 is configured to generate a plurality of computing units. Orchestration system 101 includes a scheduler 102. Scheduler 102 may be configured to deploy the computing units to one or more computing unit hosts 111, 121. In some embodiments, the computing units are deployed to the same computing unit host. In other embodiments, the computing units are deployed to a plurality of computing unit hosts.

Scheduler 102 may deploy a computing unit to a computing unit host based on a label, such as a key-value pair, attached to the computing unit. Labels are intended to be used to specify identifying attributes of the computing unit that are meaningful and relevant to users, but do not directly imply semantics to the core system. Labels may be used to organize and to select subsets of computing units. Labels can be attached to a computing unit at creation time and subsequently added and modified at any time.

A computing unit includes associated metadata. For example, the associated metadata may be associated with a cluster identity, a namespace identity, a computing unit identity, and/or one or more computing unit labels. The cluster identity identifies a cluster to which the computing unit is associated. The namespace identity identifies a virtual cluster to which the computing unit is associated. System 100 may support multiple virtual clusters backed by the same physical cluster. These virtual clusters are called namespaces. For example, system 100 may include namespaces such as “default,” “kube-system” (a namespace for objects created by an orchestration system, such as Kubernetes), and “kube-public” (a namespace created automatically and is readable by all users). The computing unit identity identifies the computing unit. A computing unit is assigned a unique ID.

The metadata associated with a computing unit may be stored by API Server 103. API Server 103 is configured to store the names and locations of each computing unit in system 100. API Server 103 may be configured to communicate using JSON. API Server 103 is configured to process and validate REST requests and update state of the API objects in etcd (a distributed key value datastore), thereby allowing users to configure computing unit and containers across computing unit hosts.

A computing unit includes one or more containers. A container is configured to implement a virtual instance of a single application or microservice. The one or more containers of the computing unit are configured to share the same resources and local network of the computing unit host on which the computing unit is deployed.

When deployed to a computing unit host, a computing unit has an associated IP address. The lifetime of a computing unit is ephemeral in nature. As a result, the IP address assigned to the computing unit may be reassigned to a different computing unit that is deployed to the computing unit host. In some embodiments, a computing unit is migrated from one computing unit host to a different computing unit host of the cluster. The computing unit may be assigned a different IP address on the different workload host.

Computing unit host 111 is configured to receive a set of one or more computing units 112 from scheduler 102. Each computing unit of the set of one or more computing unit 112 has an associated IP address. A computing unit of the set of one or more computing units 112 may be configured to communicate with another computing unit of the set of one or more computing unit 112, with another computing unit included in the set of one or more computing unit 122, or with an endpoint external to system 100.

When a computing unit is terminated, the IP address assigned to the terminated computing unit may be reused and assigned to a different computing unit. A computing unit may be destroyed. Each time a computing unit is resurrected, it is assigned a new IP address. This makes it difficult to associate a flow event with a particular computing unit.

Computing unit host 111 includes host kernel 113. Host kernel 113 is configured to control access to the CPU associated with computing unit host 111, memory associated with computing unit host 111, input/output requests associated with computing unit host 111, and networking associated with computing hosts 111.

Flow log agent 114 is configured to monitor API Server 103 to determine metadata associated with the one or more computing units 112 and/or the metadata associated with the one or more computing units 122. Flow log agent 114 is configured to extract and correlate metadata and network policy for the one or more computing units of computing unit host 111 and the one or more computing units of the one or more other computing unit hosts of the cluster. For example, flow log agent 114 may have access to a data store that stores a data structure identifying the permissions associated with a computing unit. Flow log agent 114 may use such information to determine which computing units of the cluster to which a computing unit is permitted to communicate and which computing units of the cluster to which the computing unit is not permitted to communicate.

Flow log agent 114 is configured to program kernel 113 to include flow log data plane 115. Flow log data plane 115 is configured to cause kernel 113 to generate flow events associated with each of the computing units on the host. A flow event may include an IP address associated with a source computing unit and a destination computing unit, a source port, and a protocol used. For example, a first computing unit of the set of one or more computing units 112 may communicate with another computing unit in the set of one or more computing unit 112 or a computing unit included in the set of one or more computing unit 122. Flow log data plane 115 may cause kernel 113 to record the standard network 5-tuple as a flow event and to provide the flow event to flow log agent 114.

Flow log agent 114 is configured to attach packet analyzer 117 (e.g., enhanced Berkeley Packet Filter) to network interface 116. Packet analyzer 117 is attached to sed/recv calls on the socket. This ensures that events for a single connection associating process information to the network flow (defined by the 5-tuple) are received. Packet analyzer 117 may be part of a collector that collects flow events. Events may be added as input to the collector by updating an event poller to dispatch registered events, adding handlers to the collector and register for TypeTcpv4Events and TypeUdpv4Events, and forwarding the events to the collector.

In some embodiments, network interface 116 is a virtual network interface, such as a virtual Ethernet port, a network tunnel connection, or a network tap connection. In some embodiments, network interface 116 is a physical network interface, such as a network interface card. Packet analyzer 117 is preconfigured (e.g., by a daemon running on the computing unit host) with network namespace information, which enables packet analyzer 117 to lookup a socket that is associated with the network namespace.

In response to receiving a data packet (e.g., a data packet sent from a computing unit 112 or a data packet sent to computing unit 112), packet analyzer 117 is configured to obtain information associated with the data packet by using information included in the standard network 5-tuple flow data to perform a lookup of socket information. Packet analyzer 117 is configured to call a helper function associated with host kernel 113 to lookup the socket passing in the network namespace id. Host kernel 113 is configured to provide socket information to packet analyzer 117. In response to receiving the socket information, packet analyzer 117 is configured to extract network statistics, such as round-trip time, a size of a send window, etc., from the socket information. The round-trip time and the size of the send window may indicate whether there are any network connection problems associated with computing unit 112. For example, a low round-trip time (e.g., a round-trip time less than a threshold round-trip time) may indicate that the network connection associated with computing unit 112 is not experiencing any problems while a high round-trip time (e.g., a round-trip time greater than the threshold round-trip time) may indicate that the network connection associated with computing unit 112 is experiencing problems. A large send window size (e.g., a window size greater than a window size threshold) may indicate that a TCP socket is ready to receive data packets while a small send window size (e.g., a window size less than the window size threshold) may indicate that the TCP socket has scaled back and is rejecting data packets. Packet analyzer 117 is configured to store the network statistics in a map. The network statistics may be associated with a timestamp and stored in a tracking data structure, such as the map. Packet analyzer 117 is configured to provide the network statistics to a user space program executing by flow log agent 114. In some embodiments, the network statistics are provided periodically to the user space program. In some embodiments, the user space program is configured to poll for the network statistics stored in the map. The user space program is configured to associate the network statistics with the connection.

In some embodiments, packet analyzer 117 is configured to use one or more kernel hooks to obtain additional information associated with the data packet. For example, packet analyzer 117 may use a netlink socket along with NFLogs to obtain information associated with a network policy acting on network traffic. Packet analyzer 117 may use a conntrack hook, which provides connection tracking to obtain network address translated (NAT) information. For example, a data packet received at computing unit 112 may have the IP address of computing unit 112 as the destination IP address. Computing unit 112 may include one or more containers having corresponding IP addresses that are different than the IP address of computing unit 112. The data packet may be forwarded to one of the containers. The destination IP address of computing unit 112 may be translated to the IP address of the container that received the data packet.

Flow log agent 114 may be configured to program host kernel 113 to provide additional information associated with the data packet, such as network statistics, network policy information, NAT information, etc. In response to receiving the additional information associated with the data packet, flow log agent 114 may associate the additional information with a flow event for a particular computing unit, such one of the one or more computing units 112.

Flow log agent 114 is configured to determine the computing unit to which the flow event pertains. Flow log agent 114 may determine this information based on the IP address associated with a computing unit or based on network interface associated with a computing unit. Flow log agent 114 is configured to generate a scalable network flow event by correlating the metadata associated with the computing unit with the flow event information and/or the additional information associated with the data packet. Flow log agent 114 is configured to store the scalable network flow event in a flow log. A computing unit is running one or more processes. Flow log agent 114 is configured to include additional fields, such as a process name field and a process id field, to the flow log metadata for a scalable network flow event. This enables a single flow event to be attributed to one of the processes running in the computing unit. Each event included in the flow log includes the pertinent information associated with a computing unit when the flow log entry is generated. Thus, when the flow log is reviewed at a later time, the flow log may be easily understood as to which computing unit communicated with which other computing unit in the cluster and/or endpoints external to the cluster and with which process the flow log event is associated because the flow log events are associated with a particular computing unit and a particular process.

A containerized application is comprised of a plurality of different processes. The containerized application includes one or more computing units that include one or more corresponding containers. In some embodiments, a computing unit includes a single container that provides a process. In some embodiments, a computing unit includes a plurality of containers that provide a plurality of processes. The number of computing units that provide the same process may be increased or decreased over time. Each of the computing units providing the same process may be referred to as a replica set. A flow log agent may be configured to aggregate scalable network flow events on a per replica set basis. This may not provide useful information about the process for analysis purposes because it provides an incomplete view of the process due to the ephemeral nature of a computing unit and makes it difficult to determine if there are any problems with the process at any point in time.

Instead, for an aggregation interval (e.g., 10 minutes), flow log agent 114 is configured to aggregate scalable network flow events for the one or more replica sets providing the process that have the same process name prefix. This enables an overall view of the process within the aggregation interval to be inferred and enables potential problems associated with the process to be identified. For example, the number of times a process restarted, changed, or crashed may be determined. A process that has been restarted more than a threshold number of times within the aggregation interval may indicate malicious activity associated with the process.

Flow log agent 114 identifies the scalable network flow events associated with the same process based on the process name information stored in a scalable network flow event.

In some embodiments, there is a single process associated with a process name prefix, but the process id associated with a process is changing because the process has been torn down, restarted, crashed, etc. Flow log agent 114 is configured to indicate in the data structure the number of times that the process id associated with the process has changed. Table 1 illustrates “Scenario 1” where a process “A” with “process id” of “1234” on source endpoint X initiated a flow to destination Y.

In some embodiments, there are a plurality of processes associated with a process name prefix. Instead of recording each process id for a particular process in the data structure, the flow log agent may set a flag or store an identifier, such as “*”, to indicate that a plurality of process ids are associated with the process. This may reduce the amount of data stored by the flow log. Table 1 illustrates a “Scenario 2” where a flow from source endpoint X to endpoint Y was received by process “B” with two process IDs during the aggregation interval. When the flow log is sent to flow log analyzer 141, the flag or identifier may indicate to flow log analyzer 141 that there may have been a problem with the process within the aggregation interval.

In some embodiments, there are a plurality of processes associated with a process name prefix. Flow log agent 114 is configured to aggregate the number of processes that share the process name prefix and the number of process ids associated with the plurality of processes. Instead of aggregating the individual process names and the individual process ids in the data structure, flow log agent 114 may be configured to represent the individual process names and/or the individual process ids using a flag or an identifier as “*” to indicate that a plurality of processes share the process name prefix. This reduces the amount of information that is stored by the flow log, enables the flow log to handle an increase in scale of replica sets during the aggregation interval, and reduces the amount of information that is transmitted from flog log analyzer 114 to flow log analyzer 141. Table 1 illustrates a “Scenario 3” where 10 unique processes having the process name prefix initiated a flow to destination Y. “Scenario 3” indicates that there are 14 different process IDs amongst the 10 unique processes.

In some embodiments, flow log agent 114 is configured to separately aggregate information for a threshold number of unique process names, beyond which the other processes having unique names are jointly aggregated. For example, the threshold number of unique process names may be two. Flow log agent 114 may separately aggregate information for the first and second processes, but information for other processes having the prefix is jointly aggregated. This reduces the amount of information that is stored by the flow log, enables the flow log to handle an increase in scale of replica sets during the aggregation interval, and reduces the amount of information that is transmitted from flow log agent 114 to flow log analyzer 141

TABLE 1

| | | | | process_ | process_ | process_ | num_process_ |
|---|---|---|---|---|---|---|---|
| Scenario | Source | Destination | Reporter | name | count | id | ids |
| 1 | X | Y | source | A | 1 | 1234 | 1 |
| 2 | X | Y | destination | B | 1 | * | 2 |
| 3 | X | Y | source | * | 10 | * | 14 |

After the aggregation interval has passed, flow log agent 114 is configured to provide the aggregated information, via network 131, to flow log analyzer 141. By periodically providing the aggregated information, flow log analyzer 141 can determine a specific time period where a particular process of a containerized application may have been experiencing problems. Network 131 may be one or more of the following: a local area network, a wide area network, a wired network, a wireless network, the Internet, an intranet, or any other appropriate communication network.

Computing unit host 121 may be configured in a similar manner to computing unit host 111 as described above. Computing unit host 121 includes a set of computing units 122, a network interface 126, a packet analyzer 127, a Host Kernel 123, a Flow Log Agent 124, and a Flow Log Data Plane 125.

Flow log analyzer 141 is configured to receive aggregated information (e.g., a plurality of flow logs comprising a plurality of flow events) from flow log agents 114, 124 and to store the aggregated information in flow log store 151. Flow log analyzer 141 is implemented on one or more computing devices (e.g., computer, server, cloud computing device, etc.). Flow log analyzer 141 is configured to analyze the aggregated information to determine whether there are any problems with a computing unit or a process executing by a computing unit based on the plurality of flow logs. Flow log analyzer 141 is configured to determine if a particular process needs to be scaled up based on a size of a send window included in the aggregated information. In some embodiments, flow log analyzer 141 may send to orchestration system 101 a command to scale up a particular process by deploying one or more additional computing units to one or more of the computing unit hosts 111, 121.

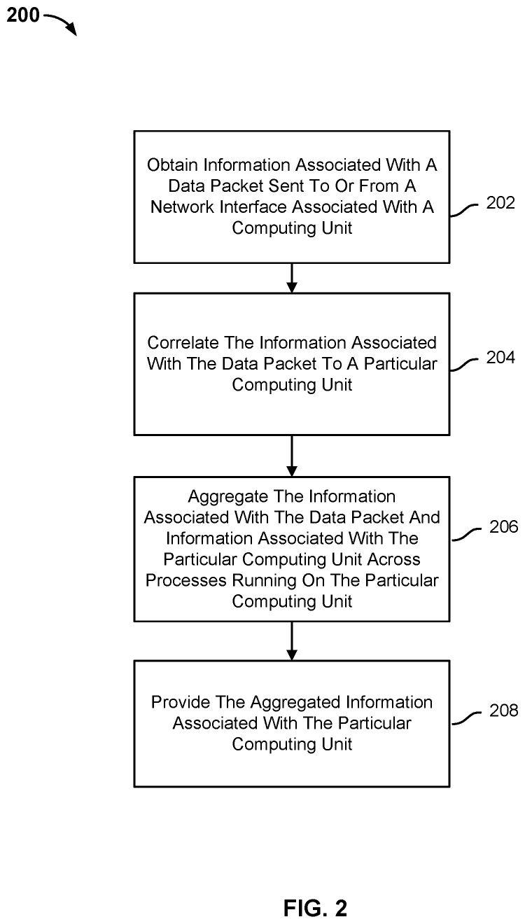

FIG. 2 is a flow diagram illustrating an embodiment of a process for obtaining, correlating, and aggregating flow events. In the example shown, portions of process 200 may be implemented by a packet analyzer, such as packet analyzers 117, 127. Portions of process 200 may be implemented by a flow log agent, such as flow log agents 114, 124.

At 202, information associated a data packet sent to or from a network interface associated with a computing unit is obtained. A packet analyzer, such as an enhanced Berkeley Packet Filter, is attached to a network interface associated with a computing unit.

A packet is received at network interface associated with a computing unit and in response to receiving the data packet (e.g., a data packet sent from/to a computing unit), the packet analyzer is configured to obtain information associated with the data packet by using information included in the standard network 5-tuple flow data to perform a lookup of socket information. The packet analyzer is configured to call a kernel helper function to lookup the socket passing in the network namespace id. The kernel is configured to provide socket information to the packet analyzer. In response to receiving the socket information, the packet analyzer is configured to extract network statistics, such as round-trip time, a size of a send window, etc., from the socket information. The round-trip time and the size of the send window may indicate whether there are any network connection problems associated with the computing unit. The packet analyzer is configured to provide the network statistics to a flow log agent.

In some embodiments, the packet analyzer is configured to use one or more kernel hooks to obtain additional information associated with the data packet. For example, the packet analyzer may use a netlink socket along with NFLogs to obtain information associated with a network policy acting on network traffic. The packet analyzer may use a conntrack hook, which provides connection tracking to obtain network address translated (NAT) information. For example, a data packet received at a computing unit may have the IP address of the computing unit as the destination IP address.

At 204, the information associated with the data packet is correlated to a particular computing unit associated with the cluster node.

The flow log agent is configured to program the kernel to provide flow events associated with each of the computing units on the computing unit host to the flow log agent. A flow event may include a source IP address, a destination IP address, a source port, a destination port, and a protocol. In response to receiving a flow event, the flow log agent is configured to correlate the flow event with metadata associated with a computing unit (e.g., cluster identity, namespace identity, computing unit identity, one or more computing unit labels) to generate a scalable network flow event and log the scalable network flow event in a flow log. A computing unit is running one or more processes. The flow log agent is configured to include additional fields, such as a process name field and a process id field, to the flow log metadata for a scalable network flow event. This enables a single flow event to be attributed to one of the processes running in the computing unit. For example, the scalable network flow event in the flow log may have the form {source IP address, destination IP address, source port, destination port, protocol, computing unit metadata, process name, process id}.

The flow log agent may be configured to program the kernel of the computing unit host on which the flow log agent is deployed to provide the additional information associated with the data packet, such as network statistics, network policy information, NAT information, etc. In response to receiving the additional information associated with the data packet, the flow log agent may associate the additional information with a flow event for a particular computing unit. In some embodiments, the additional information is appended to a scalable network flow event.

At 206, information associated with the data packet and information associated with the particular computing unit are aggregated across processes running on the particular computing unit. The aggregated information for a process at least includes a source internet protocol (IP) address, a destination IP address, a source port, a destination port, a protocol, a process name, and a process identifier.

A containerized application is comprised of a plurality of different processes. The containerized application includes one or more computing units that include one or more corresponding containers. In some embodiments, a computing unit includes a single container that provides a process. In some embodiments, a computing unit includes a plurality of containers that provide a plurality of processes. The number of computing units that provide the same process may be increased or decreased over time. Each of the computing units providing the same process may be referred to as a replica set. A flow log agent may be configured to aggregate scalable network flow events on a per replica set basis. This may not provide useful information about the process for analysis purposes because it provides an incomplete view of the process due to the ephemeral nature of a computing unit and makes it difficult to determine if there are any problems with the process at any point in time.

Instead, for an aggregation interval (e.g., 10 minutes), the flow log agent is configured to aggregate scalable network flow events for the one or more replica sets providing process(es) that have the same process name prefix. This enables an overall view of the process within the aggregation interval to be inferred and enables potential problems associated with the process to be identified. For example, the number of times a process restarted, changed, or crashed may be determined. A process that has been restarted more than a threshold number of times within the aggregation interval may indicate malicious activity associated with the process.

The flow log agent identifies the scalable network flow events associated with the same process based on the process name information stored in a scalable network flow event.

At 208, the aggregated information associated with the particular computing unit is provided. The flow log agent may store the scalable network flow events associated with the computing unit host in a flow log and periodically (e.g., every hour, every day, every week, etc.) send the flow log to a flow log analyzer. In other embodiments, the flow log agent is configured to send a flow log to a flow log analyzer in response to receiving a command. In other embodiments, the flow log agent is configured to send a flow log to a flow log analyzer after a threshold number of flow event entries have accumulated in the flow log. In some embodiments, the flow log analyzer polls the flow log for entries.

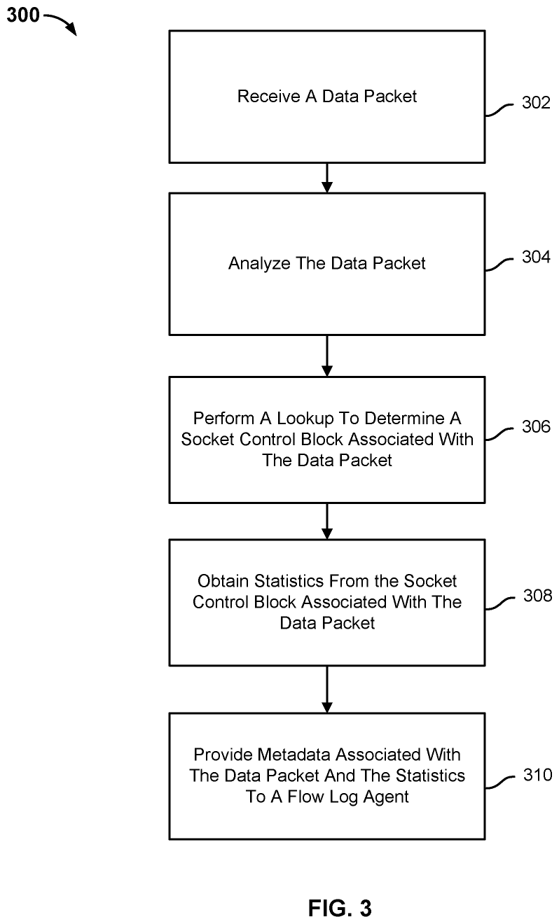

FIG. 3 is a flow diagram illustrating an embodiment of a process for obtaining information associated with a data packet. In the example shown, process 300 may be implemented by a packet analyzer, such as packet analyzers 117, 127. In some embodiments, process 300 is implemented to perform some or all of step 202 of process 200.

At 302, a data packet is received. The data packet is received at a network interface associated with a computing unit. In some embodiments, the network interface associated with the computing unit is a virtual network interface, such as a virtual Ethernet port, a network tunnel connection, or a network tap connection. In some embodiments, the network interface associated with the computing unit is a physical network interface, such as a network interface card. A packet analyzer is attached to a network interface associated with a computing unit. The packet analyzer receives TCP and UDP events.

At 304, the data packet is analyzed. The packet analyzer is configured to obtain information associated with the data packet by using information included in the standard network 5-tuple flow data to perform a lookup of socket information.

In some embodiments, the packet analyzer is configured to use one or more kernel hooks to obtain additional information associated with the data packet. For example, the packet analyzer may use a netlink socket along with NFLogs to obtain information associated with a network policy acting on network traffic. The packet analyzer may use a conntrack hook, which provides connection tracking to obtain NAT information. For example, a data packet received at a computing unit may have the IP address of the computing unit as the destination IP address. The computing unit may include one or more containers having corresponding IP addresses that are different than the IP address of the computing unit. The data packet may be forwarded to one of the containers. The destination IP address of the computing unit may be translated to the IP address of the container that received the data packet.

At 306, a lookup is performed to determine a socket control block associated with the data packet. The packet analyzer is configured to call a kernel helper function to lookup the socket passing in the network namespace id.

At 308, statistics from the socket control block associated with the data packet are obtained. The kernel is configured to provide socket information to the packet analyzer. In response to receiving the socket information, the packet analyzer is configured to extract network statistics, such as round-trip time, a size of a send window, etc., from the socket information. The round-trip time and the size of the send window may indicate whether there are any network connection problems associated with the computing unit. For example, a low round-trip time (e.g., a round-trip time less than a threshold round-trip time) may indicate that the network connection associated with the computing unit is not experiencing any problems while a high round-trip time (e.g., a round-trip time greater than the threshold round-trip time) may indicate that the network connection associated with the computing unit is experiencing problems. A large send window size (e.g., a window size greater than a window size threshold) may indicate that a TCP socket is ready to receive data packets while a small send window size (e.g., a window size less than the window size threshold) may indicate that the TCP socket has scaled back and is rejecting data packets.

At 310, metadata associated with the data packet and the statistics are provided to a user space. The packet analyzer is configured to provide the network statistics and/or the obtained additional information to a flow log agent (e.g., user space program).

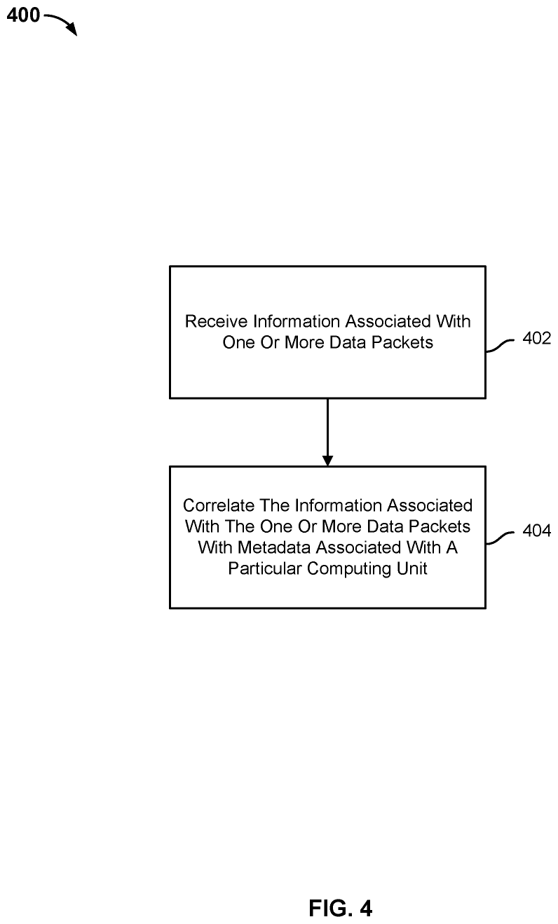

FIG. 4 is a flow diagram illustrating an embodiment of a process of correlating a flow event with a particular computing unit. In the example shown, process 400 may be implemented by a flow log agent, such as flow log agents 114, 124. In some embodiments, process 400 is implemented to perform some or all of step 204 of process 200.

At 402, information associated with one or more data packets is received. A computing unit host may host a plurality of computing units. When deployed to a computing unit host, a computing unit has an associated IP address. The lifetime of a computing unit is ephemeral in nature. As a result, the IP address assigned to the computing unit may be reassigned to a different computing unit that is deployed to the computing unit host. In some embodiments, a computing unit is migrated from one computing unit host to a different computing unit host. The computing unit may be assigned a different IP address on the different computing unit host.

A flow log agent may receive flow events from a plurality of different computing units. A flow event includes the standard network 5-tuple flow data (source IP address, source port, destination IP address, destination port, protocol). Analyzing the flow data solely using the standard network 5-tuple flow data makes it difficult to determine whether there are any network connection problems associated with any of the computing units.

At 404, the information associated with the one or more data packets is correlated with metadata associated with a particular computing unit. In response to receiving a flow event, the flow log agent is configured to correlate the flow event with metadata associated with a computing unit (e.g., cluster identity, namespace identity, computing unit identity, one or more computing unit labels) to generate a scalable network flow event and log the scalable network flow event in a flow log. A computing unit is running one or more processes. The flow log agent is configured to include additional fields, such as a process name field and a process id field, to the flow log metadata for a scalable network flow event. This enables a single flow event to be attributed to one of the processes running in the computing unit. When the flow log is reviewed at a later time, the flow log event may be easily understood as to which computing unit communicated with which other computing units in the cluster and/or endpoints external to the cluster and with which process the flow log event is associated because the flow log events are associated with a particular computing unit and a particular process.

In some embodiments, additional information associated with the data packet, such as network statistics, network policy information, NAT information, etc. are correlated with a particular computing unit.

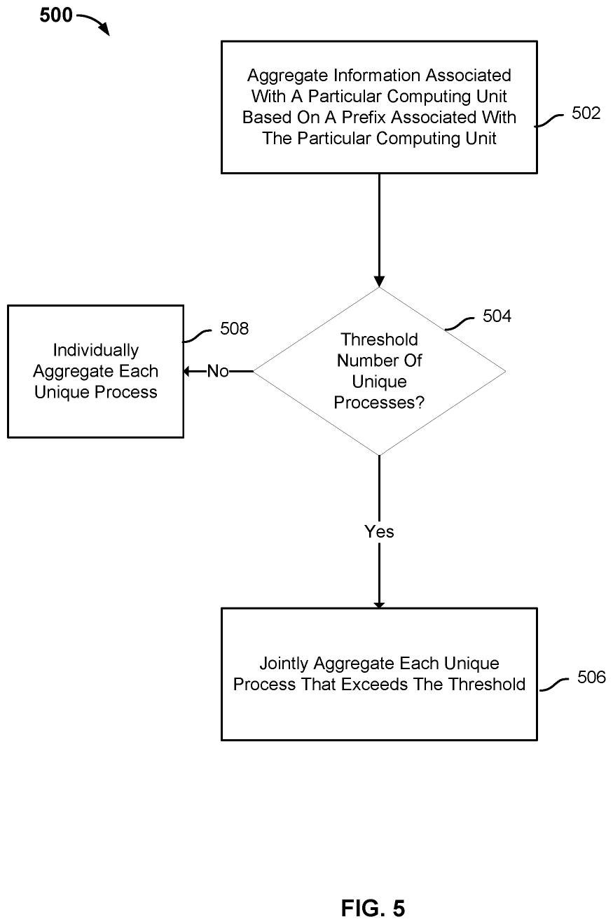

FIG. 5 is a flow diagram illustrating an embodiment of a process for aggregating information associated with a data packet and information associated with a particular computing unit across processes running in a particular computing unit. In the example shown, process 500 may be implemented by a flow log agent, such as flow log agents 114, 124. In some embodiments, process 500 is implemented to perform some or all of step 206 of process 200.

At 502, information associated with a particular computing unit is aggregated based on a prefix associated with the particular computing unit.

At 504, it is determined whether the prefix associated with the particular computing unit is associated with a threshold number of unique processes. In the event is determined that the prefix associated with the particular computing unit is associated with a threshold number of unique processes, process 500 proceeds to 506 where each unique process that exceeds the threshold number is jointly aggregated. In the event is determined that the prefix associated with the particular computing unit is not associated with a threshold number of unique processes, process 500 proceeds to 508 where each unique process is individually aggregated.

For example, the threshold number of unique process names may be two. The flow log agent may separately aggregate information for the first and second processes, but information for other processes having the prefix (e.g., the third process, the fourth process, . . . , the nth process) is jointly aggregated. This reduces the amount of information that is stored by the flow log, enables the flow log to handle an increase in scale of replica sets during the aggregation interval, and reduces the amount of information that is transmitted to the flow log analyzer.

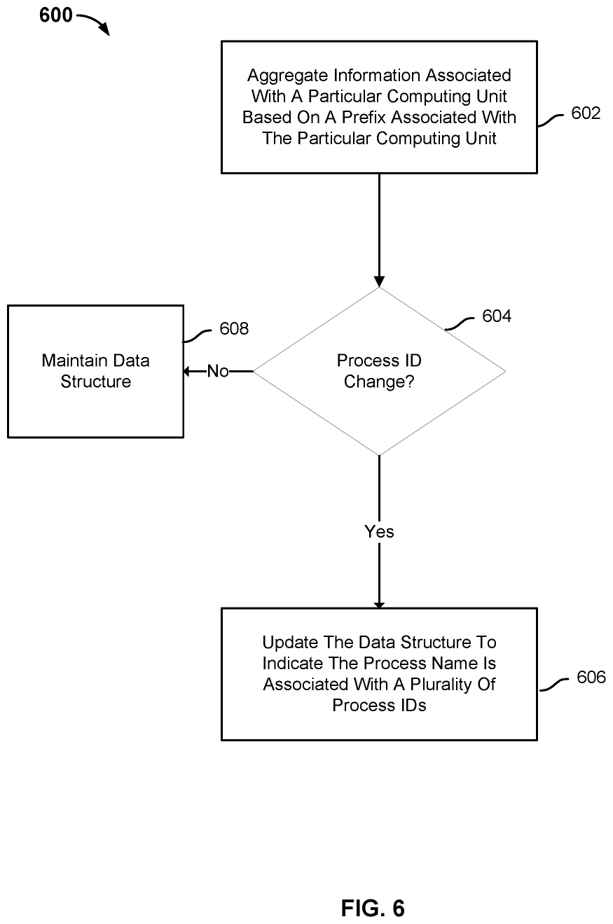

FIG. 6 is a flow diagram illustrating an embodiment of a process for aggregating information associated with a data packet with information associated with a particular computing unit across processes running on a particular computing unit. In the example shown, process 600 may be implemented by a flow log agent, such as flow log agents 114, 124. In some embodiments, process 600 is implemented to perform some or all of step 206 of process 200.

At 602, information associated with a particular computing unit is aggregated based on a prefix associated with the particular computing unit.

At 604, it is determined whether a process ID associated with the particular computing unit has changed. In some embodiments, there is a single computing unit associated with a process name prefix, but the process ID associated with a process is changing because the process has been torn down, restarted, crashed, etc.

In the event the process ID associated with the particular computing unit has changed, process 600 proceeds to 606 where the data structure is updated to indicate the process name is associated with a plurality of process IDs. Instead of recording each process id for a particular process, the flow log agent may set a flag or store an identifier, such as “*”, to indicate that a plurality of process ids are associated with the process. This may reduce the amount of data stored by the flow log. When the flow log is sent to a flow log analyzer, the flag or identifier may indicate to the flow log analyzer that there may have been a problem with the process within the aggregation interval.

In the event the process ID associated with the particular computing unit has not changed, process 600 proceeds to 608 where the data structure is maintained.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor, wherein the processor:
obtains information associated with data packets sent to or from a network interface associated with a cluster node;
correlates the information associated with the data packets to a particular computing unit associated with the cluster node; and
aggregates the information associated with the data packets with information associated with the particular computing unit across processes running on the particular computing unit; and
a communication interface coupled to the processor, wherein the communication interface provides the aggregated information to a flow log analyzer.

2. The system of claim 1, wherein the information associated with the data packets is obtained using an enhanced Berkeley packet filter.

3. The system of claim 2, wherein the enhanced Berkeley packet filter is attached to the network interface associated with a kernel of the cluster node.

4. The system of claim 1, wherein the information associated with the data packets includes at least one of a round trip time or a message window size, a network address translated source internet protocol address, and/or a network address translated destination internet protocol address.

5. The system of claim 1, wherein the information associated with the data packets is correlated to the particular computing unit based on metadata associated with the particular computing unit.

6. The system of claim 1, wherein the aggregated information at least includes a source internet protocol (IP) address, a destination IP address, a source port, a destination port, a protocol, a process name, and a process identifier.

7. The system of claim 1, wherein the information associated with the particular computing unit is aggregated based on a prefix associated with the particular computing unit.

8. The system of claim 7, wherein the particular computing unit executes one or more processes.

9. The system of claim 8, wherein each of the one or more processes is associated with a corresponding process name and a corresponding process identifier.

10. The system of claim 8, wherein to aggregate the information associated with the particular computing unit, the processor records a number of times the corresponding process identifier associated with a process has changed.

11. The system of claim 8, wherein to aggregate the information associated with the particular computing unit, the processor records a number of unique process identifiers in the event the particular computing unit is executing a plurality of processes.

12. The system of claim 8, wherein to aggregate the information associated with the particular computing unit, the processor aggregates information for a threshold number of processes having the prefix associated with the particular computing unit.

13. The system of claim 12, wherein the processor separately aggregates information in the event a number of processes having the prefix are less than or equal to the threshold number of processes having the prefix associated with the particular computing unit.

14. The system of claim 12, wherein the processor separately aggregates information for the threshold number of processes having the prefix associated with the particular computing unit and jointly aggregate information for processes having the prefix associated with the particular computing unit that exceed the threshold number of processes.

15. The system of claim 1, wherein to aggregate the information associated with the particular computing unit, the processor includes one or more indicators that indicate a potential problem with a process.

16. The system of claim 1, wherein the processor aggregates the information associated with the particular computing unit for an aggregation interval.

17. The system of claim 1, wherein the aggregated information associated with the particular computing unit is provided to the flow log analyzer via the communication interface after an aggregation interval has passed.

18. The system of claim 1, wherein the information associated with a data packet includes a network address translated internet protocol address.

19. A method, comprising:
obtaining information associated with a data packet sent to or from a network interface associated with a cluster node;
correlating the information associated with the data packet to a particular computing unit associated with the cluster node;
aggregating the information associated with the data packet with information associated with the particular computing unit across processes running on particular computing unit; and
providing the aggregated information to a flow log analyzer.

20. A computer program product embodied in a non-transitory computer readable medium and comprising computer instructions for:
obtaining information associated with a data packet sent to or from a network interface associated with a cluster node;
correlating the information associated with the data packet to a particular computing unit associated with the cluster node;
aggregating the information associated with the data packet with information associated with the particular computing unit across processes running on the particular computing unit; and
providing the aggregated information to a flow log analyzer.
